(19) United States
(12) Patent Application Publication
(10) Pub. No.: US 2006/0158339 A1
(43) Pub. Date: Jul. 20, 2006

(54) Automatic garage door closing device

(76) Inventor: Steven Nigel Dario Brundula, Chandler, AZ (US)

Correspondence Address: Steven Brundula, 113 S. Lakeview Blvd., Chandler, AZ, 85225, US

(21) Appl. No.: 11/294,665

(22) Filed: Dec. 5, 2005

Related U.S. Application Data
(60) Provisional application No. 60/634,059, filed on Dec. 7, 2004.

(51) Int. Cl. G08B 21/00; B60R 25/00; G08C 19/00

(52) U.S. Cl. 340/686.1; 340/5.71; 340/825.72

(57) ABSTRACT

A product that resides inside of a garage with a working wireless electric garage door opener, the product detects when the garage door is open for too long and when the garage door is open too long the product sends out warnings, then after the appropriate conditions occur the product can close the garage door. The product additionally requires no special installation of sensors or wires.

### TECHNICAL FIELD

The technical field of this device is in electronics. The more specific areas of electrical expertise needed for this product is digital electronics for the control and timing circuitry, analog electronic knowledge for the alarm and device powering considerations (the whole design can be done in analog circuitry if preferred), and wireless RF electronic experience (although if a universal garage door design is purchased and interfaced no RF experience is necessary).

### BACKGROUND

Most people who have a garage door have accidentally left it open. Leaving the garage door open can have consequences such as; having belongings stolen from the garage or even the house, animals such as snakes can enter the garage to live, and in colder climates pipes can freeze and break. Prior art has come up with devices to fix this issue but are too cumbersome to use. Wires need to be connected, sensors need to be mounted, usually expensive, complicated and time consuming. This led to the idea of creating a device that can be mounted on a garage door, powered off of a battery, work with existing garage door openers, provide a warning before closing the door, and be very simple to install.

### SUMMARY OF INVENTION

The Background has led to two most probable and different devices, 1) the first and the simplest is a device that mounts to the inside of a garage door and detects the tilt of the garage door. When the garage door is not perpendicular to the ground for greater than a certain amount of time, the module sets off an alarm. A certain amount of time after that if the garage door is still not perpendicular to the ground and the device has not been turned off, a signal is sent to the garage door opener to close the garage door or to a wall mounted module that presses the garage door open/close button to close the garage. 2) The second device is almost the same as the first except that instead of setting off an alarm, it sends a phone call or text message to a specified phone number. Replying by pressing a touch-tone button on the phone or a text message with a specific message will tell the device to try and close the garage door.

### DETAILED DESCRIPTION

Device 1 (see FIG. 3) consists of a sensor such as a tilt sensor, a universal garage door remote or wall-mounted device to press the garage door open close button (see FIG. 2 and FIG. 4), control inputs/switches, a system controller, and an alarm device(s).

Device 2 would be the same as Device 1, as it would contain a sensor a universal garage door remote or wall mounted device to press the garage door open/close button, control inputs/switches, a system controller, and an alarm device; in addition however it would also contain a telephone module to make the module contain a cell phone, or it would talk to another module that is plugged into a phone line.

The sensor could be one or more of many different devices, such as measurement sensors to measure the distance the garage door is off the floor, or tilt sensors to measure the tilt of the garage door. Due to simplicity the tilt sensor would be preferable.

The universal garage door remote is what stores all the codes to all the different garage doors; this allows one product capable of working on thousands of different garage doors. When the universal garage door remote is signaled, the universal garage door remote transmitter sends an RF signal to the garage door opener to close the garage door. An alternative to using the universal garage door remote would be to send a wireless signal to a module that would press the garage door open/close button (see FIG. 2).

The alarm device(s) are audible and/or visual; the purpose is to warn anyone around the garage door that the door is going to soon close. Most probably a flashing light and a siren or beep would be the preferable alarm method. Another probable alarm device is a device that calls a phone number if the garage door is open too long. The additional device can be a module that plugs into a standard phone line, or a separate mobile phone built into the automatic garage door closing device.

The control inputs/switches control a) turning on and off the device, b) programming the universal remote for a specific garage door type, c) changing the values of how long the garage door can be open before the alarm goes off, d) change how long the alarm goes off before the signal is sent to close the garage door, and e) to change the phone number to send a text message to warning that the garage door is open. The device would also need to have a method to show the current settings so a simple to complex display can be used to show setting values.

The system controller regulates the operation of the device; the operation it performs is the following. If the door is sensed to be open, the controller waits a specified amount of time for the garage door to close. If after this variable time the garage door is still not closed and the phone module is not part of this system then the controller starts the alarm(s). The alarm will continue for another specified amount of time and if by the end of that time the garage door is still open, the controller then sends an appropriate signal to close the garage door. If the phone module is part of the system then a phone call or text message is sent to a specified phone number. The phone module then waits for a response such as the press of a specific touch-tone button, or to receive a text message. Pressing different options can do different things, returning/pressing 1 closes the garage door, 2 leaves the garage door open and doesn't warn you anymore, 3 leaves the garage door open and will warn you again after a specified amount of time if the garage door has still not been closed.

The controller also checks the status of the input switches/sensors to see if any of the system parameters such as delay time until sending off an alarm is to be changed. A potentiometer or switch that rotates adjusts the amount of time delay from when the door is opened until an alarm goes off, a toggle switch turns the system on and off. The phone module includes a display to show the phone number to call when the garage door is open. All systems have indicator lights to show if any of the batteries are going low, when the batteries are low alarms also go off but with different intensities to warn the user to change the system batteries.

All the sensors and features built into a garage door opener continue to work and are not inhibited with this device. Likewise if a car or a person blocks a door sensor, this device will try but will not be able to close the garage door.

### DESCRIPTION OF DRAWINGS

FIG. 1: An illustration of how one of the devices may look mounted to a garage door.

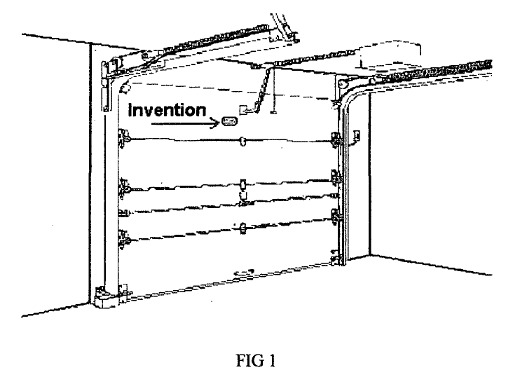

FIG. 2. Illustration of a device that can press a garage door button and close a garage door.

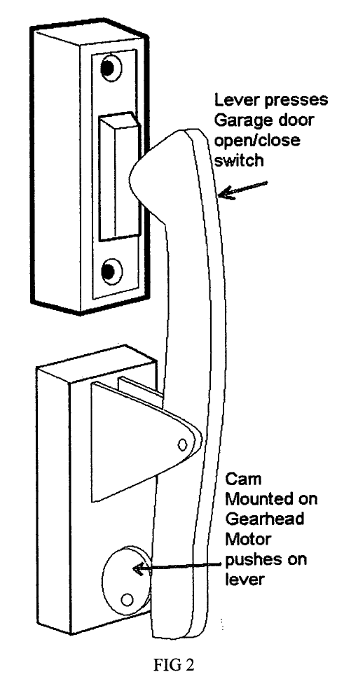

FIG. 3: High-level block diagram of an automatic garage door closer with an RF transmitter that sends the same signal as a garage door remote to close the garage door.

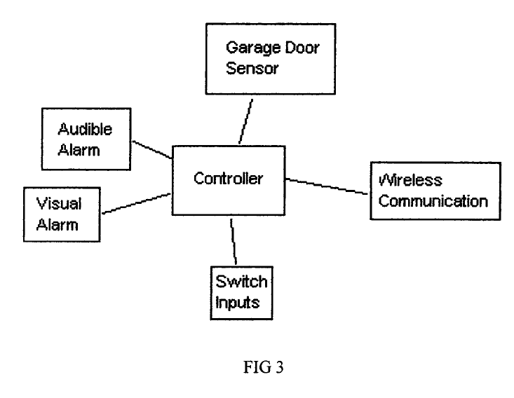

FIG. 4: High-level block diagram of an automatic garage door closer that presses the garage door open/close button on the wall to close the garage door.

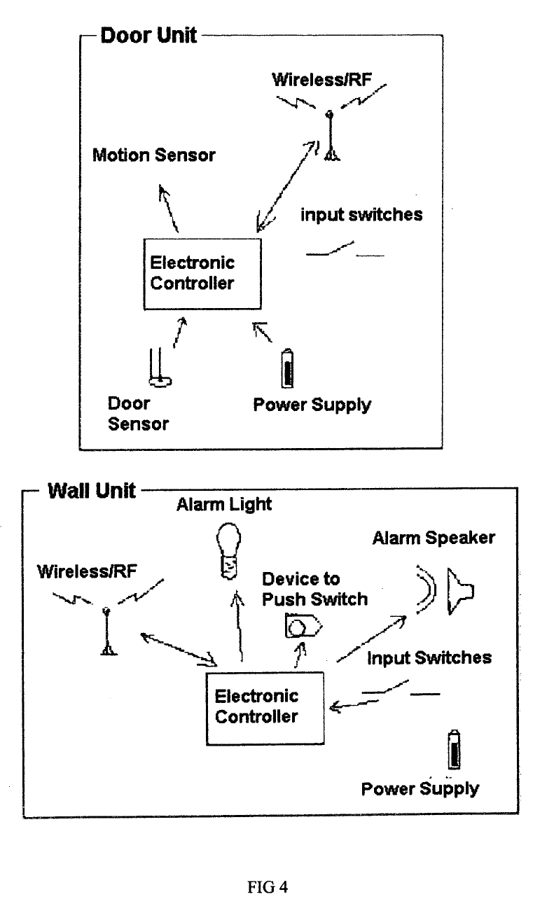

1. A device that when mounted to the inside of a garage door can automatically close a garage door, and contains:
a sensor requiring no special installation (built into device) to detect when the garage door is open,
a wireless method to close the garage door,
an alarm to warn the user of important circumstances such as, the garage door is about to close or the units power supply is low,
input controls,
and a controller circuit or circuits to interface all the circuitry to each other.

2. The automatic door closer as in claim 1, wherein the wireless method to close the garage door is an electrical/mechanical device that presses the garage door open/close switch on the garage wall to close the garage door.

3. The Automatic door closer as in claim 1, wherein a wireless transmitter that operates just like a regular garage door remote control to open or close a garage door, is used to close the garage door.

4. The automatic door closer as in claim 1, wherein the sensor to detect if the garage door is open is a tilt sensor built into the unit, and the unit is mounted to the inside of the garage door.

5. The automatic door closer as in claim 1, wherein the input signals or switches:
enable or disable the device,
configure or change information for sending alarms,
program the transmitter to communicate with the correct garage door,
test that the system works,
and can change the amount of delay until the door is automatically close.

6. The automatic door closer as in claim 1, wherein the alarm that warns the user is:
a light such as a flashing light, and/or
a sound such as a beep or siren.

7. The automatic door closing device as in claim 1, wherein the alarm that warns the user of the door being open is a built in mobile phone or pager that sends a text message sent to another phone number.
The automatic door closer closes the garage door when it receives a valid text message confirming to shut the garage.

8. The automatic door closing device as in claim 1, wherein the alarm that warns the user of the door being open is a transmitter that communicates to another module that is connected into a phone line.
When the garage door is left open too long the module calls a programmed phone number.
The automatic door closer closes the garage door when it receives a valid confirmation to close the garage door over the phone line from the module.

9. The automatic door closer as in claim 1, wherein the alarm that warns the user of the door being open is an email to a preprogrammed email address.
The automatic door closer closes the garage door when it receives a valid confirmation to close the garage door over another email message.
